(19) United States
(12) Patent Application Publication
(10) Pub. No.: US 2013/0146663 A1
(43) Pub. Date: Jun. 13, 2013

(54) SYSTEM AND METHOD FOR CONVERGING RFID BUILDING SECURITY WITH PKI TECHNIQUES

(71) Applicants: Jason Dean Hart, Fremont, CA (US); Matthew Patrick Herscovitch, Fremont, CA (US)

(72) Inventors: Jason Dean Hart, Fremont, CA (US); Matthew Patrick Herscovitch, Fremont, CA (US)

(21) Appl. No.: 13/816,642

(22) PCT Filed: Aug. 12, 2011
(86) PCT No.: PCT/AU2011/001028

§ 371 Date: Feb. 12, 2013

Related U.S. Application Data
(60) Provisional application No. 61/373,437, filed on Aug. 13, 2010.

(51) Int. Cl. G06K 1/12; G06K 7/10

(52) U.S. Cl. CPC G06K 1/12; G06K 7/10297
USPC 235/439; 235/492

(57) ABSTRACT

A system and method for dynamically retrieving and storing local building/facility access card information on an access card is provided. An access card is provided to a local facility access card reader and is authenticated for the local facility by providing local facility access card information from the reader to be stored inside a Public Key Infrastructure (PKI) certificate relating to the access card.

### FIELD OF THE INVENTION

The present invention relates to building and/or location access security. More particularly, the present invention provides a system and method for converging building and location security employing RFID access systems, with PKI techniques.

### DESCRIPTION OF THE RELATED ART

Building or location access systems employing RFID technology are generally stand alone systems requiring an authorised user to carry location-specific cards to gain access to a particular area. As a result, authorised users are required to carry multiple building or location access cards to gain access to multiple or different areas.

For example, a company may lease office space in a portion of a building, along with one or more car parking spaces. The security card required to access the car parking spaces will be different to the security card required to gain access to the office space of the building.

Commonality of security access systems could be achieved by system owners collaborating and trusting a single access card using a single radio protocol. However, such a practice is regarded as challenging when considering financial and organisational issues.

The present invention advantageously provides an alternative to existing building or location security access systems. The invention according to certain embodiments may advantageously be used to integrate trusted security techniques with existing building security access systems.

### SUMMARY OF THE INVENTION

According to a first aspect of the invention, there is provided a method and system for dynamically retrieving and storing local building/facility access card information on an access card. An access card is provided to a local facility access card reader and is authenticated for the local facility by providing local facility access card information from the reader to be stored inside a Public Key Infrastructure (PKI) certificate relating to the access card.

In accordance with another aspect of the invention, the local facility access card reader is a RFID reader operating at 125 kHz and/or 13.56 MHz. Further, the local facility access card information includes facility name, the type of access card, the frequency, modulation, facility code and serial number.

According to still a further aspect of the invention, the reader authenticates an access card by reading the PKI certificate from the access card, and verifying the PKI certificate and relevant attributes stored thereon.

### BRIEF DESCRIPTION OF THE DRAWINGS

The invention will now be described in a non-limiting manner with respect to a preferred embodiment in which:

FIG. 1 is an overview of the operation of low frequency door readers in accordance with a preferred embodiment of the present invention; and

FIG. 2 is an overview of the operation of high frequency door readers in accordance with a preferred embodiment of the present invention.

### DETAILED DESCRIPTION OF PREFERRED EMBODIMENTS

In the following discussion and in the claims, the terms “including” and “includes” are used, and are to be read, in an open-ended fashion, and should be interpreted to mean “including, but not limited to . . . ”.

The present invention is described in relation to building/facility access systems using RFID technology. It is to be appreciated however, that the invention is not to be limited to building/facility access systems. The present invention may be incorporated in various types of locations with security access, including but not limited to, car parks, gated communities and vestibules. Further, the communication technology need not be limited to RFID systems. The present invention may be incorporated using alternative radio technologies as will be apparent to one of skill in the art.

Current building security systems utilize RFID proximity cards to allow location access to authorised users. Proximity cards generally comprise an integrated circuit used to store and process information, as well as an antenna tuned to a suitable frequency to receive and transmit relevant information. Proximity cards may further include security mechanisms supporting encryption, as employed in such formats as MIFARE and DESFire.

The present invention provides a system and method for storing multiple encrypted building access codes and radio frequency modulation information in a public-private key certificate on a single building access card, such as a legacy proximity card or encrypted access card with formats such as MIFARE and DESFire, or similar.

A suitable card support device, such as an electronic smartcard badge holder described in International Application PCT/AU2010/000508, preferably retrieves the local building's information from the certificate on the user's card and dynamically programs the building access portion of the building access card upon which the certificate is stored. In the absence of a suitable card support device, the above mentioned process may be facilitated through a modified door access reader.

The present invention allows the user's incorporated certificate to control the “personality” of the building access card, enabling the card to change between different building access card modulations, brands and serial numbers, in addition to allowing the card to support encrypted building systems. The user maintains control of the card, and the descried functionality occurs seamlessly and in real-time.

Once the “personality” of the card has been set for the local building system, the user may provide their single building card for relevant legacy building readers at that location. The user may then provide their access card when returning to their “home” location and the relevant reader will revert the card back to the home access settings.

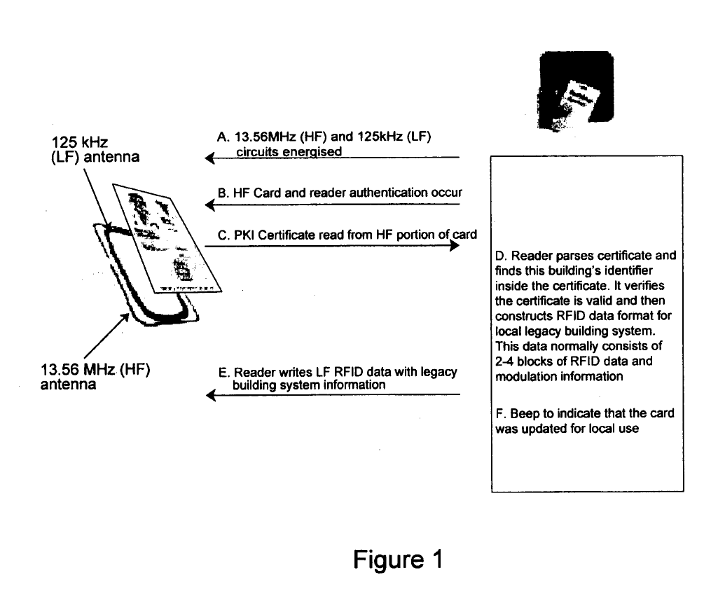

The following example, with reference to FIG. 1, describes the flow of information between the building access card (in this case, a smart card or similar) and the door reader operating at 125 kHz to support local door/access systems. The system described refers to a modified door reader. However, as described above, functionality of the present invention may be supported by a suitable card support device.

As shown in FIG. 1, a security access card is presented to a modified door reader, which is capable of reading the PKI certificate from the card utilizing high frequency communication techniques, preferably operating at 13.56 MHz. Once the user's certificate is verified, attributes that exist securely within the certificate are parsed to retrieve the local building access card information.

The local building access card information preferably includes, but is not limited to, the facility name, the type of access card, the frequency, modulation, facility code and serial number. This information is securely protected using suitable security techniques; preferably PKI encryption where the electronic signature of the PKI certificate prevents unauthorized tampering. Additionally, the certificate can be verified to determine whether physical access credentials are valid and whether the access card may be authenticated.

Once the door reader has extracted and processed the local building access card information, the reader preferably reprograms the user's access card with the relevant local building system information. Preferably, the interaction and reprogramming process takes less than 150 ms.

Upon reprogramming the access card, the reader preferably sends the user's facility code and serial to the host/central reader security system network via its output port. The access card may now be used at any of the legacy readers within the facility.

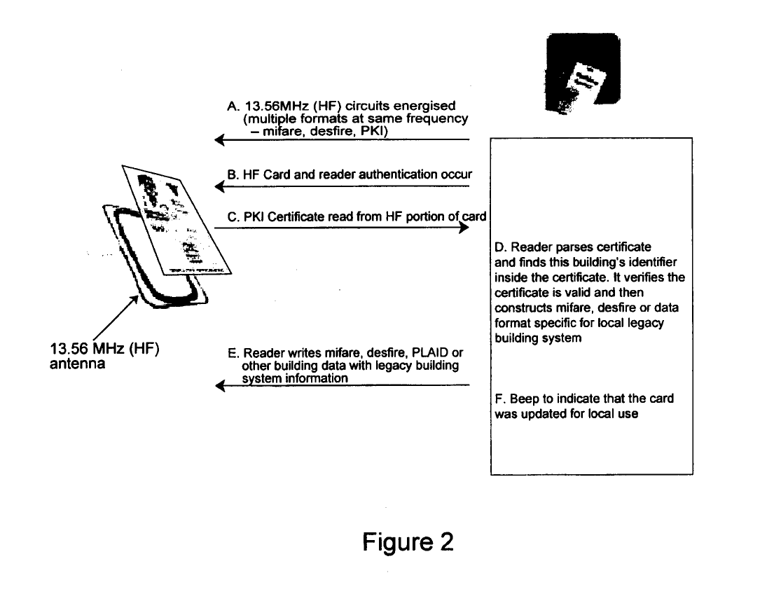

The present invention may also be used with buildings utilizing high security encryption card access systems operating at higher frequencies, such as 13.56 MHz. A preferred embodiment of the present invention operating at the higher frequency is shown in FIG. 2.

The challenge with high security systems is key management, with most systems using a well known or static key. Prior security systems have tended to move away from using encrypted systems in this field, as the keys ultimately become known given that they are shared or exposed to many devices, or are not securely transported.

The present invention ameliorates these prior art concerns by allowing the PKI certificate to be used as the primary source of the physical access encryption keys. This facilitates one access card to dynamically host multiple building systems and formats in multiple buildings in the high frequency range.

The present invention advantageously provides strong public-private key security techniques enabling building access systems to leverage elements of high security without the need to modify legacy building systems. The present invention provides particular advantages where it is not desirous for organizations to provide a facility security host or manager access to high frequency employee ID cards to add local encryption keys. In accordance with the present invention, the organization can update users' certificate to contain the necessary keys and serial numbers for gaining access to the facility or building. Accordingly, when a user access card is presented to a suitable building reader, the system will read and authenticate the user's certificate from their card and update the presented access card with new building information according to the local format (for example, MIFARE, DESFire, PLAID or similar).

It is to be understood that the above embodiments have been provided only by way of exemplification of this invention, and that further modifications and improvements thereto, as would be apparent to persons skilled in the relevant art, are deemed to fall within the broad scope and ambit of the current invention described and claimed herein.

1. A method for dynamically storing local facility access card information on an access card, the method including the steps of:
providing an access card to a local facility access card reader; and
authenticating the access card for the local facility by providing local facility access card information to be stored inside a Public Key Infrastructure (PKI) certificate relating to the access card.

2. The method of claim 1, wherein the local facility access card reader is a RFID reader operating at 125 kHz and/or 13.56 MHz.

3. The method of claim 1, wherein the local facility access card information includes facility name, the type of access card, the frequency, modulation, facility code and serial number.

4. The method of claim 1, wherein the authenticating step further includes:
reading the PKI certificate from the access card; and
verifying the PKI certificate and relevant attributes stored thereon.

5. A system for dynamically retrieving and storing local facility access card information on an access card, including:
a RFID access card reader, connected to a network;
wherein the RFID access card reader retrieves the local facility access card information from the network and authenticates an access card by providing the local facility access card information to be stored inside a Public Key Infrastructure (PKI) certificate relating to the access card.

6. The system of claim 5, wherein the RFID access card reader operates at 125 kHz and/or 13.56 MHz.

7. The system of claim 5, wherein the local facility access card information includes facility name, the type of access card, the frequency, modulation, facility code and serial number.

8. The system of claim 5, wherein the reader authenticates an access card by reading the PKI certificate from the access card, and verifying the PKI certificate and relevant attributes stored thereon.
